(19) United States
(12) Patent Application Publication
(10) Pub. No.: US 2010/0016468 A1
(43) Pub. Date: Jan. 21, 2010

(54) TREATED EXPANDED POLYSTYRENE FOAM

(76) Inventor: Todd B. BERGSTROM, Lakeville, MN (US)

Correspondence Address: HUSCH BLACKWELL SANDERS LLP, 4801 Main Street, Suite 1000, KANSAS CITY, MO, 64112, US

(21) Appl. No.: 12/175,310

(22) Filed: Jul. 17, 2008

(51) Int. Cl. C09D 5/14; C08F 112/08

(52) U.S. Cl. 523/122; 526/346

(57) ABSTRACT

This invention relates generally to a expanded polystyrene foam having at least one organic compound operably bound to the expanded polystyrene and substantially coating the outer surface of the individual expanded polystyrene beads. Organic compounds hereof may be operably bound to the expanded polystyrene through an electrostatic interaction and may be selected from pesticides, insecticides, termiticides, fungicides, moldicides, bactericides, mildewicides, and combinations thereof.

### BACKGROUND OF THE INVENTION

Polystyrene is an aromatic polymer made from the aromatic monomer styrene which is a liquid hydrocarbon that is commercially manufactured from petroleum by the chemical industry. Polystyrene is a thermoplastic substance and normally exists in solid state at room temperature, but will melt if heated. Pure solid polystyrene is a colorless, hard plastic with limited flexibility that can be cast into fine detail molds. It is economical and is commonly used for producing plastic model assembly kits, license plate frames, plastic cutlery, CD “jewel” cases, and many other objects where a fairly rigid, economical plastic is desired.

Expandable polystyrene is the raw material or resin most commonly used for the molding of expanded polystyrene (EPS) products EPS is a relatively inexpensive material, lightweight, aesthetically pleasing, and possesses low thermal conductivity. It is particularly useful in the manufacture of packaging products and is also ideal as a construction material. EPS is therefore sometimes used in structural insulated panel building systems, other building structures, as molded packing material for cushioning fragile equipment inside boxes, as packing “peanuts”, as non-weight-bearing architectural structures (such as pillars), and also in crafts and model building, particularly architectural models.

Expandable polystyrene is typically manufactured in the form of very small polystyrene beads having an average molecular weight between 160,000 and 260,000 and an individual bead's diameter can vary between 0.2-3.0 mm. EPS is produced from a mixture of about 90-95% expandable polystyrene resin and about 5-10% of a gaseous blowing agent such as pentane. The density of expanded polystyrene varies greatly from around 10 kg/m³ to 80 kg/m³ depending on manufacturing parameters. The expandable polystyrene resin is expanded by the application of steam or some other form of heat to create the expanded polystyrene foam having microscopic cells filled with trapped air.

However, difficulties have arisen when EPS foam is used in building and structural materials, such as in-foam board insulation and structural insulated panels, because the EPS foam often encounters environmental hazards and pests including insects, termites, beetles, fungi, mold, mildew, bacteria and the like. To address these issues, for example, inorganic based insecticides and pesticides, typically borate compounds, have been used to treat EPS foam building products. This is a disadvantage because inorganic insecticides and pesticides typically need to be added at high levels. Alternatively, organic based insecticides have been used wherein the polystyrene beads are impregnated with a pesticide, an insecticide or the like. However, after the beads are expanded, a large portion of the pesticide remains within the bead. This is disadvantageous because it has been shown that it is the pesticide near the surface of each expandable bead that is most effective at repelling insects. Accordingly, impregnating pesticides within expandable beads may require as much as 50 to 100 times more insecticide than may otherwise be required to achieve an effective amount. This is not only costly but also detrimental to the environment.

Accordingly, it would be advantageous to provide an expanded polystyrene foam that is treated with an organic insecticide, pesticide, or the like that is resistant to common pests and other environmental hazards as well as providing a polystyrene foam that can effectively repel pests using a relatively low dose of a pesticide.

### SUMMARY OF THE INVENTION

This invention relates generally to an expanded polystyrene foam having at least one organic compound operably bound to the expanded polystyrene and substantially coating the outer surface of the individual expanded polystyrene beads. Organic compounds hereof may be operably bound to the expanded polystyrene through an electrostatic interaction and may be selected from pesticides, insecticides, termiticides, fungicides, moldicides, bactericides, mildewicides, and combinations thereof in any form including, but not limited to, a powder, a liquid, an emulsion, and an immiscible concentrate.

It will be appreciated by those skilled in the art that the present invention is not limited to the particular processes, compositions, or methodologies described, as these may vary. It is also to be understood that the terminology used in the description is for the purpose of describing the particular versions or embodiments only, and is not intended to limit the scope of the present invention which will be limited only by the appended claims. Moreover, unless defined otherwise, all technical and scientific terms used herein have the same meanings as commonly understood by one of ordinary skill in the art. Although any methods and materials similar or equivalent to those described herein can be used in the practice or testing of embodiments of the present invention, the preferred methods, devices, and materials are now described. Nothing herein is to be construed as an admission that the invention is not entitled to antedate such disclosure by virtue of prior invention.

### DETAILED DESCRIPTION OF THE INVENTION

There is provided herein a treated expanded polystyrene foam that generally includes at least one organic compound operably bound to the expanded polystyrene and substantially coating an outer surface of each individual expanded polystyrene bead. The expanded polystyrene foam hereof includes EPS prepared by any method now known or hereafter developed including, but not limited to, expansion by steam treatment or other heating methods. It will be appreciated that the EPS hereof also includes manufactured products made from such expanded polystyrene including, but not limited to, building products such as board insulation and structural building panels.

In certain embodiments, the individual EPS beads each include an outer surface that is substantially covered or coated by at least one organic compound. The organic compound may contact the expandable polystyrene prior to heating and expansion processing to created the coated or treated EPS hereof. Alternatively, the organic compound may contact the EPS following expansion processing. In these embodiments, the individual EPS beads may be coated with the organic compound prior to molding the EPS into its final form. In certain other embodiments, the final form molded EPS may be contacted with an organic compound wherein the outer surface of the molded EPS may be coated with the organic compound.

Organic compounds are particularly preferred for use in the present invention because they are believed to bind more readily to EPS beads than do inorganic salts such as sodium or calcium borate. Moreover, unlike inorganic salts, the organic compounds hereof may not be soluble in water and may therefore help to prevent a molded article from leaching and losing its pesticidal activity. In certain embodiments, binding of the organic compound to the EPS occurs during expansion wherein an electrostatic interaction, typically hydrogen bonding, occurs between the polystyrene monomers and the organic compound molecules. Alternatively, water from the steam used to heat the expandable polystyrene resin may act as a carrier and bring the organic compound molecules into close proximity with the polystyrene monomers thereby allowing an electrostatic interaction to occur. It is believed that the electrostatic interaction between an organic compound and one or more EPS beads may allow fusion of the beads to occur more readily during the molding process and may also enhance the physical properties of the final molded article.

The treated EPS foam hereof generally includes an effective amount of at least one organic compound. As used herein, an “effective amount” of a composition is a predetermined amount calculated to achieve the desired effect, i.e., to effectively deter the infestation of the EPS foam from one or more pests or environmental hazards. Effective amounts of compounds of the present invention can be measured by the ability of the compound to deter pest infestation, movement, and destruction of manufactured materials or underlying materials. In certain embodiments, the treated EPS foam hereof includes at least one organic compound present in a concentration sufficient to substantially cover or coat the outer surface of each EPS bead in a molded article. In certain other embodiments, the treated EPS foam includes from about 0.01 wt % to about 1.0 wt % of at least one organic compound, more preferably from about 0.01 wt % to about 0.15 wt %, and most preferably from about 0.05 wt % to about 0.1 wt %. It will be appreciated that the weight to volume ratio of organic compound to EPS in the final form molded product may vary based on the density of EPS in the final molded article, the type of final molded article, and/or the particular application for which it is being used. For example, the desired amount of expandable polystyrene resin and organic pesticide may be any amount necessary to produce the desired weight to volume ratio of the organic compound in a molded article having a desired density. It will be appreciated that the density of the final molded article may be calculated based on the amount of resin provided. The concentration of the organic compound in the final molded article may thereby be predicted. For example, about 0.80 lbs of an organic pesticide, such as, for example, imidacloprid, can be equally distributed over about 1000 lbs of EPS.

Organic compounds suitable for use in the present invention may be any organic compound now known or hereafter developed that can kill, repel or deter growth of insects, termites, beetles, fungi, mold, and/or mildew. It will be appreciated by those skilled in the art that the organic compound hereof may be in any form suitable for use in the present invention including, but not limited to, powders, liquids, emulsions, and immiscible concentrates. In particular, the organic compounds hereof may include, but are not limited to, pesticides, insecticides, fungicides, moldicides, mildewicides, bactericides, derivatives thereof, and mixtures or combinations thereof. In certain embodiments, an organic pesticide is particularly preferred and is a neonicotinoid selected from the group consisting of imidacloprid, nithiazine, thiamethoxam, dinotefuran, nitenpyram, thiacloprid, clothianadin, derivatives thereof, and mixtures or combinations thereof. In other embodiments, the organic compound is selected from the group consisting of imidacloprid, thiacloprid, fipronil, clothianidin, thiamethoxam, acetamiprid, allethrin, bifenthrin, chlorfenapyr, cyhalothrin, phoxim, chloropyriphos, and pyrethroides-series insecticides such as permethrin, decamethrin, cypermethrin, deltamethrin, tralomethrin, etofenprox, fenvalerate, cyfluthrin, derivatives thereof, and mixtures or combinations thereof. In certain other embodiments, the organic compound is imadacloprid or related compounds as described in U.S. Pat. No. 6,936,624, entitled “Agents for Preserving Technical Materials Against Insects”, filed Jun. 21, 2001, which document is hereby incorporated by reference in its entirety, and emulsions and immiscible concentrates thereof.

In certain embodiments, it will be appreciated by those skilled in the art that the organic compound hereof may optionally be mixed with one or more additives without departing from the scope of the present invention. Available additives include, but are not limited to, fire retardants, colorants, binders, anti-static agents, sealants, and the like.

### EXAMPLE

In the following example, the effectiveness of deterring termite attack on an imidacloprid-treated EPS foam and plain EPS foam was tested. The testing consisted of exposing the polystyrene foam against subterranean termites, especially the species Mastotermes darwiniensis and Coptotermes acinaciformis. Briefly, a plain EPS test sample and imidacloprid-treated EPS samples were installed adhered to a concrete block which would simulate application of below grade insulation to a concrete foundation. The samples were left exposed to the termites for a period of one year. Unless otherwise noted all insecticide concentrations are provided as a wt %, and the units used with the wt % system-are pounds per pound.

The test materials included plain EPS and EPS treated with imidacloprid (0.025). The samples were examined for a damage rating after one year. The test materials and the results of this test are presented in Table 1.

TABLE 1

Damage Rating, %

| | Negligible | Minor | Bad | Severe |
|---|---|---|---|---|
| Plain EPS | 0 | 25 | 5 | 70 |
| Imidacloprid | 50 | 25 | 25 | 0 |
| Treated | | | | |

The imidacloprid treated EPS suffered significantly less damage than the plain EPS.

From the foregoing, it may be seen that the inventive treated expanded polystyrene foam is particularly well suited for the proposed usages thereof. Furthermore, since certain changes may be made in the above invention without departing from the scope hereof, it is intended that all matter contained in the above description or shown in the accompanying drawing be interpreted as illustrative and not in a limiting sense. It is also to be understood that the following claims are to cover certain generic and specific features described herein.

We claim:

1. A treated expanded polystyrene comprising a expanded polystyrene having at least one organic compound operably bound to the expanded polystyrene and substantially coating the outer surface of the individual expanded polystyrene beads.

2. The treated expanded polystyrene of claim 1, wherein the at least one organic compound is selected from pesticides, insecticides, termiticides, fungicides, moldicides, bactericides, mildewicides, derivatives thereof, and mixtures thereof.

3. The treated expanded polystyrene of claim 1, wherein the at least one organic compound is a termiticide.

4. The treated expanded polystyrene of claim 1, wherein the at least one organic compound is imidacloprid or imidacloprid-containing mixtures.

5. The treated expanded polystyrene of claim 1, wherein the at least one organic compound is in a form selected from a powder, a liquid, an emulsion, and an immiscible concentrate.

6. The treated expanded polystyrene of claim 1, wherein the at least one organic compound is bound to the outer surface of the individual expanded polystyrene beads through an electrostatic interaction.

7. The treated expanded polystyrene of claim 1, wherein the at least one organic compound is provided in an amount sufficient to kill a pest that comes into contact with the treated expanded polystyrene.

8. The treated expanded polystyrene of claim 1, wherein the at least one organic compound is from about 0.01 wt % to about 1.0 wt % of the expanded polystyrene.

9. The treated expanded polystyrene of claim 1, wherein the at least one organic compound is from about 0.01 wt % up to about 0.15 wt % of the expanded polystyrene.

10. The expanded polystyrene of claim 1, wherein the expanded polystyrene is substantially resistant to pests.

11. The expandable polystyrene of claim 1, wherein the expanded polystyrene is substantially resistant to termites.

12. An expanded polystyrene molded article comprising an expanded polystyrene having at least one organic compound operably bound to the expanded polystyrene and substantially coating the outer surface of the individual expanded polystyrene beads.

13. The molded article of claim 12, wherein the organic compound is selected from pesticides, insecticides, termiticide, fungicides, moldicides, bactericides, mildewicides and combinations thereof.

14. The molded article of claim 12, wherein the at least one organic compound is a termiticide.

15. The molded article of claim 12, wherein the at least one organic compound is imidacloprid or imidacloprid containing mixtures.

16. The molded article of claim 12, wherein the at least one organic compound is in a form selected from a powder, a liquid, an emulsion, and an immiscible concentrate.

17. The molded article of claim 12, wherein the molded article is substantially resistant to pests.

18. The molded article of claim 12, wherein the molded article is substantially resistant to termites.
